(19) United States
(12) Patent Application Publication
(10) Pub. No.: US 2013/0033360 A1
(43) Pub. Date: Feb. 7, 2013

(54) ADAPTIVE SPEED PAY AUTOMOTIVE MODULE

(71) Applicants: Michael Kurtz, Lake in the Hills, IL (US); Stefan Dziaba, Cortland, IL (US); Larry Cannek, Naperville, IL (US)

(72) Inventors: Michael Kurtz, Lake in the Hills, IL (US); Stefan Dziaba, Cortland, IL (US); Larry Cannek, Naperville, IL (US)

(21) Appl. No.: 13/416,294

(22) Filed: Mar. 9, 2012

Related U.S. Application Data
(63) Continuation of application No. 13/194,680, filed on Jul. 29, 2011.
(60) Provisional application No. 61/368,932, filed on Jul. 29, 2010.

(51) Int. Cl. G05B 19/00

(52) U.S. Cl. 340/5.62

(57) ABSTRACT

A communication device is disclosed. The communication device has a first assembly including a controller, a first communication element, and a speed pay communication element. The controller is configured to use the first communication element to control an operation of a user-operated assembly. The communication device also has a second assembly including an electronics element configured to operate with a speed pay system. The second assembly is removably attachable to the first assembly. The controller, the speed pay communication element, and the electronics element are configured to operate with the speed pay system when the first assembly and the second assembly are attached to each other. The operation of the communication device with the speed pay system is disabled when the first assembly and the second assembly are detached from each other.

This application is a Continuation of U.S. application Ser. No. 13/194,680, filed on Jul. 29, 2011, which claimed the benefit of domestic priority of U.S. provisional application 61/368,932, filed Jul. 29, 2010, the subject matters of which are incorporated herein by reference.

### TECHNICAL FIELD

This disclosure is directed to a communication device and, more particularly, to a communication device that operates with a speed/quick pay system.

### BACKGROUND

Speed/quick pay systems have become increasingly prevalent in the marketplace. Using speed/quick pay systems, users may use a device having speed/quick pay electronics to quickly make transactions such as, for example, financial transactions.

One problem associated with such devices having speed/quick pay electronics is that private data belonging to a user, which may be stored on the device having speed/quick pay electronics, may be taken by unauthorized parties. For example, if a third party gains access to a device having speed/quick pay electronics, that third party may be able to take private data belonging to the owner of the device.

The present disclosure is directed to overcoming one or more of the shortcomings set forth above and/or other deficiencies in the art.

### SUMMARY OF THE DISCLOSURE

In one aspect, the present disclosure is directed to a communication device. The communication device includes a first assembly including a controller, a first communication element, and a speed pay communication element. The controller is configured to use the first communication element to control an operation of a user-operated assembly. The communication device also includes a second assembly including an electronics element configured to operate with a speed pay system. The second assembly is removably attachable to the first assembly. The controller, the speed pay communication element, and the electronics element are configured to operate with the speed pay system when the first assembly and the second assembly are attached to each other. The operation of the communication device with the speed pay system is disabled when the first assembly and the second assembly are detached from each other.

In another aspect, the present disclosure is directed toward a method for using a communication device to operate with a speed pay system. The method includes providing a first assembly including a first communication element and a speed pay communication element, and using the first communication element to control an operation of a user-operated assembly. The method also includes providing a second assembly including an electronics element, and using the electronics element to operate with a speed pay system. The method further includes attaching the first assembly and the second assembly together to allow the controller, the speed pay communication element, and the electronics element to operate with the speed pay system. The method additionally includes detaching the second assembly from the first assembly to disable the operation of the communication device with the speed pay system.

### BRIEF DESCRIPTION OF THE DRAWINGS

FIG. 1 is a diagrammatic illustration of an exemplary disclosed communication device;

FIG. 2 is another diagrammatic illustration of the exemplary disclosed communication device; and

FIG. 3 is a schematic illustration of the exemplary disclosed communication device.

### DETAILED DESCRIPTION

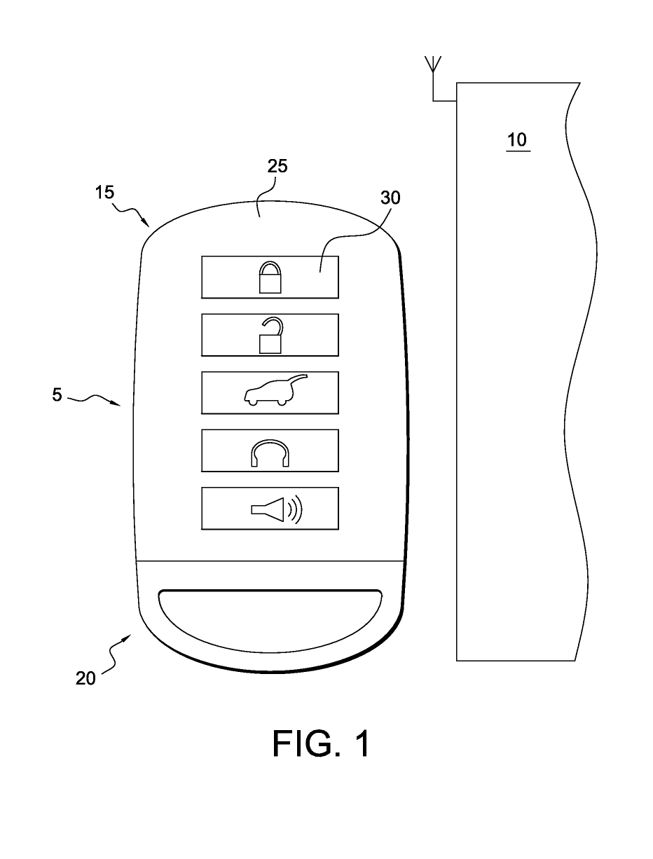

FIG. 1 illustrates an exemplary disclosed communication device 5. Communication device 5 may be, for example, a communication device associated with a user-operated assembly 10 such as a vehicle. For example, communication device 5 may be a device that allows a user to remotely operate functions of a user-operated assembly 10 such as, for example, a vehicle. For example, in one exemplary embodiment, communication device 5 may be a keyfob for a passenger vehicle. Communication device 5 may include a first assembly 15 and a second assembly 20. First assembly 15 and second assembly 20 may be removably attachable to each other, and may each work independently and in combination to control user-operated assembly 10.

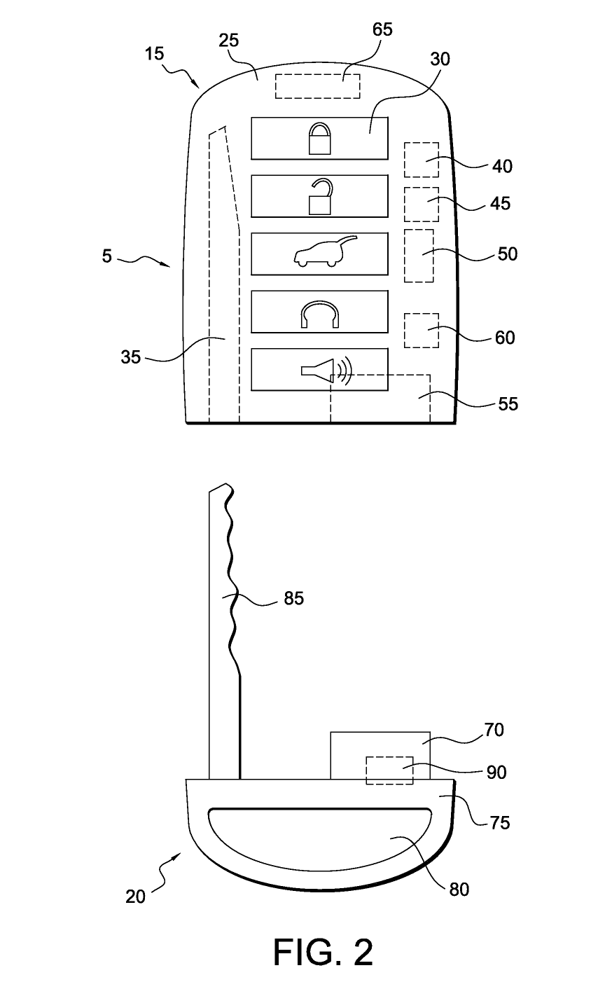

As illustrated in FIGS. 1 and 2, first assembly 15 may include a body 25, one or more input elements 30, a cavity 35, a first communication element 40, a second communication element 45, a controller 50, a connector 55, a third communication element 60, and a power source 65. First assembly 15 may be any suitable device for communicating with user-operated assembly 10 such as, for example, a fob. Body 25 may house the other elements of first assembly 15, and cavity 35 may be formed in body 25. First communication element 40 and second communication element 45 may facilitate communication between communication device 5 and user-operated assembly 10. Third communication element 60 and connector 55 may facilitate communication between first assembly 15 and second assembly 20 and/or other units in the environment of communication device 5. Power source 65 may provide power to facilitate operation of first assembly 15. First communication element 40, second communication element 45, controller 50, and third communication element 60 may be included in one or more integrated circuits (IC), or may each be a separate IC.

Body 25 may be any suitable structural body for housing the elements of first assembly 15 such as, for example, a plastic body. Body 25 may include CLASS A surfacing features. Input elements 30 may be any suitable elements for allowing a user to input commands to communication device 5 such as, for example, a keypad and/or buttons. Cavity 35 may be a cavity having an open end, so that cavity 35 may receive a portion of second assembly 20 as discussed further below. Power source 65 may be any suitable power source for providing power to first assembly 15 such as, for example, a rechargeable battery.

First communication element 40 and second communication element 45 may be any suitable elements for facilitating communication between first assembly 15 and user-operated assembly 10. For example, first communication element 40 may include a Radio Frequency (RF) antenna and circuit such as, for example, a bi-directional RF antenna and circuit. Second communication element 45 may include a Low Frequency (LF) antenna and circuit.

Controller 50 may be any suitable device for receiving and processing user input from input elements 30 for controlling an operation of the elements of first assembly 15. For example, controller 50 may include a microcontroller circuit (MCU) and/or a near-field communication device (NFC).

Connector 55 may be any suitable device for facilitating an electrical and/or mechanical connection between first assembly 15 and second assembly 20. Connector 55 may engage with a connector 70 of second assembly 20, discussed further below. Connectors 55 and 70 may form part of a sealed connection between first assembly 15 and second assembly 20 when first assembly 15 and second assembly 20 are connected, as illustrated in FIG. 1. Connectors 55 and 70 may be, for example, matching male and female connectors. For example, connector 55 may be the female connector of a universal serial bus (USB) connector, and connector 70 may be the male connector of the USB connector. Alternatively, connector 55 may be the male connector of the USB connector, and connector 70 may be the female connector of the USB connector. It is also contemplated that connectors 55 and 70 may be connectors other than USB-type connectors.

Third communication element 60 may be any suitable element for facilitating communication between communication device 5 and other activities or locations in the environment of communication device 5. For example, third communication element 60 may be a speed pay communication element that facilitates communication between communication device 5 and a speed/quick pay system (e.g., a “speed pay system”). For example, in one exemplary embodiment, third communication element may include an antenna (e.g., a “speed pay antenna”) that operates at 13.56 MHz. Thus, a user may use communication device 5 to operate with (e.g., communicate with and/or make transactions with) a speed/quick pay system, as discussed further below.

As illustrated in FIGS. 1 and 2, second assembly 20 may include connector 70, a body 75, an aperture 80, an element 85, and an electronics element 90. Body 75 may house the other elements of second assembly 20, and connector 70 may facilitate communication between first assembly 15 and second assembly 20. Aperture 80 and element 85 may facilitate a user's manipulation of second assembly 20. Electronics element 90 may facilitate communication between first assembly 15 and second assembly 20, and between communication device 5 and other activities or locations in the environment of communication device 5. It is also contemplated that second assembly 20 may include a power source similar to power source 65 such as, for example, a rechargeable battery.

Body 75 may be any suitable structural body for housing the elements of first assembly 15 such as, for example, a plastic body. Body 75 may be formed from a material that is suitable for overmolding or for use with two piece water sealed plastics. Body 75 may also include CLASS A surfacing features. Aperture 80 may facilitate a user's manipulation of second assembly 20, for example, by providing an aperture that may be received on a keychain or other holding device of a user. Element 85 may be any suitable item that may be included in communication device 5 such as, for example, a back-up or a hidden keyblade for user-operated assembly 10. For example, element 85 may be a backup key for a vehicle when user-operated assembly 10 is a vehicle. When first assembly 15 and second assembly 20 are attached together, as illustrated in FIG. 1, element 85 may be received within cavity 35 of first assembly 15. It is also contemplated that no element 85 be provided on second assembly 20 (e.g., that no hidden keyblade for user-operated assembly 10 be provided on second assembly 20).

As discussed above regarding connector 55, connector 70 may be any suitable connector that forms a connection between first assembly 15 and second assembly 20. As discussed above, connectors 55 and 70 may be, for example, matching male and female connectors. When first assembly 15 and second assembly 20 are attached, a sealed connection may be formed. Connector 70 may be disposed on an overmolded portion of second assembly 20 (in which electronics element 90 may be overmolded, as discussed below), which may be disposed oppositely to connector 55 that is disposed on first assembly 15. The overmolded portion may help to form a water-tight seal that protects electronics of first assembly 15 and second assembly 20. Body 25 of first assembly 15 and body 75 of second assembly 20 may be configured to facilitate removable attachment of first assembly 15 and second assembly 20. Connectors 55 and 70 and bodies 25 and 75 may form a water-tight sealed connection between first assembly 15 and second assembly 20.

Electronics element 90 may be any suitable element such as, for example, an IC such as an NFC, for facilitating communication between first assembly 15 and second assembly 20, and between communication device 5 and other activities or locations in the environment of communication device 5. Electronics element 90 may be overmolded onto body 75 of second assembly 20 (e.g., in the overmolded portion discussed above), which may help to provide a water-tight seal of electronics element 90. Electronics element 90 may include some or substantially all of the electronics appropriate for communicating and making transactions with a speed/quick pay system. Electronics element 90 may also include private data belonging to the user such as, for example, personal financial data. When first assembly 15 and second assembly 20 are connected via connectors 55 and 70, communication device 5 may be able to communicate with a speed/quick pay system using electronics element 90, as described further below.

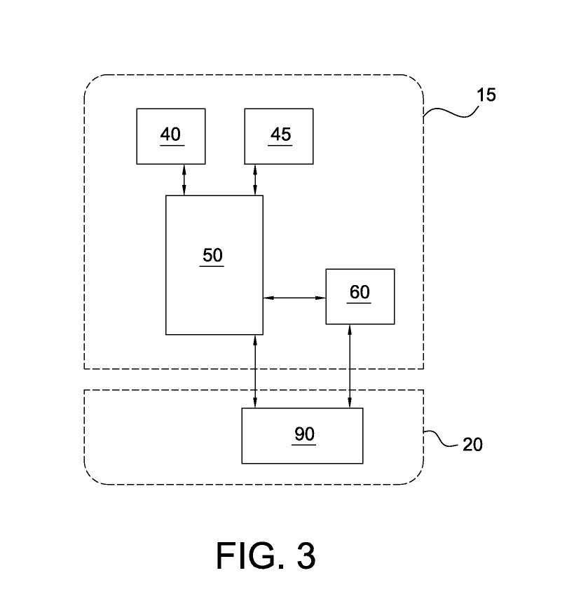

As schematically illustrated in FIG. 3, when first assembly 15 and second assembly 20 form a sealed connection including the connection formed by connectors 55 and 70, elements of both first assembly 15 and second assembly 20 may be electrically connected. Electronics element 90 may therefore be electrically connected to controller 50 and third communication element 60. Accordingly, controller 50 may control all of the elements of communication device 5 when first assembly 15 and second assembly 20 are connected, and all of the elements of communication device 5 may operate together. As discussed further below, controller 50, third communication element 60, and electronics element 90 may operate to allow a user to communicate with and make transactions with a speed/quick pay system when first assembly 15 and second assembly 20 are connected. Thus, controller 50, third communication element 60, and electronics element 90 may operate as a speed/quick pay subsystem when first assembly 15 and second assembly 20 are connected.

It is also contemplated that third communication element 60 and electronics element 90 may be substantially entirely contained in second assembly 20. In this exemplary embodiment, second assembly 20 may operate independently of first assembly 15, and connectors 55 and 70 may not be included. Thus, in this contemplated embodiment, a user may use second assembly 20 to operate with a speed/quick pay system independently of first assembly 15.

### INDUSTRIAL APPLICABILITY

The disclosed communication device may be used in any activity in which a user desires to use a communication device for a user-operated assembly to operate with (e.g., communicate with and make transactions with) a speed/quick pay system. The communication device may be used with any user-operated assembly such as, for example, a vehicle, and may be used with any type of speed/quick pay system available to a user.

A user may use communication device 5, where first assembly 15 and second assembly 20 are attached (as illustrated in FIG. 1) during a normal operation of user-operated assembly 10. For example, when the user is a driver of a vehicle, communication device 5 may be a keyfob formed by first assembly 15 and second assembly 20 being attached to each other.

When first assembly 15 and second assembly 20 are attached, the user uses communication device 5 to communicate with a speed/quick pay system. As illustrated in FIG. 3, electronics element 90 electrically communicates with controller 50 and third communication element 60 as a speed/quick pay subsystem, via the connection formed by connectors 55 and 70. Because electronics element 90 may include most or substantially all of the electronics appropriate for making transactions with a speed/quick pay system, controller 50 may control electronics element 90 to conduct calculations and processes associated with transactions and communications with a speed/quick pay system. Controller 50 controls third communication element 60 to transmit communications between a speed/quick pay system and electronics element 90 and/or controller 50, thereby allowing the user to make speed/quick pay system transactions using communication device 5.

In addition to using communication device 5 to make speed/quick pay system transactions, a user controls other operations when first assembly 15 and second assembly 20 are attached. A user controls operations of user-operated assembly 10 by inputting commands to controller 50 via input elements 30. Based on the input, controller 50 controls first communication element 40 and second communication element 45 to remotely control operations of user-operated assembly 10. For example, as indicated on the exemplary drawings on input elements 30, a user may use communication device 5 to lock or unlock a door of user-operated assembly 10, or to control an alarm feature of user-operated assembly 10.

A user detaches second assembly 20 from first assembly 15 when it is desired to substantially prevent a speed/quick pay operation of communication device 5. The user may, for example, manually pull first assembly 15 and second assembly 20 apart. Thus, a user may quickly disable the speed/quick pay subsystem of communication device 5. Once first assembly 15 and second assembly 20 are pulled apart, they will no longer form a sealed connection, and connectors 55 and 70 will be separated and will also no longer electrically connect first assembly 15 and second assembly 20. Accordingly, electronics element 90 will no longer be in electrical contact with controller 50 and third communication element 60 via the sealed connection of first assembly 15 and second assembly 20. Therefore, the speed/quick pay subsystem of communication device 5 will be disabled. First assembly 15 and second assembly 20, though, are still used independently of each other as described below.

When first assembly 15 is separated from second assembly 20, a user still uses first assembly 15 to remotely control operations of user-operated assembly 10. Similar to the operation of communication device 5 when first assembly 15 is attached to second assembly 20, even when first assembly 15 is detached and used independently of the rest of communication device 5, a user may still control operations of user-operated assembly 10 by inputting commands to controller 50 to control first communication element 40 and second communication element 45 to remotely control operations of user-operated assembly 10. Additionally, connector 55 allows first assembly 15 to interface directly to a processing device such as a computer or smart station to perform desired operations such as, for example, diagnostic tests using communication device 5 or other functionalities. However, when first assembly 15 is separated from second assembly 20, the speed/quick pay subsystem of communication device 5 is disabled, and the user may not use first assembly 15 to make speed/quick pay system transactions.

When second assembly 20 is separated from the rest of communication device 5, the user or a third party may not use first assembly 15 to make speed/quick pay system transactions. However, the user still uses element 85 of second assembly 20 as a backup device. For example, when communication device 5 is a keyfob and user-operated assembly 10 is a vehicle, a user uses element 85 as a backup key to lock and unlock user-operated assembly 10. It is also contemplated that a user may use second assembly 20 independently to make speed/quick pay transactions.

In one exemplary embodiment of communication device 5, a user maintains first assembly 15 and second assembly 20 in an attached state during normal operation of user-operated assembly 10. However, when a user desires to allow another party to use communication device 5 to control user-operated assembly 10, the user detaches first assembly 15 from second assembly 20. For example, when communication device 5 is a keyfob and user-operated assembly 10 is a vehicle, a user may detach first assembly 15 from second assembly 20 before giving first assembly 15 to a third party such as, for example, when loaning the vehicle to another user, during valet parking, or during vehicle maintenance or service. When the user gives the detached first assembly 15 to the third party, the speed/quick pay subsystem of communication device 5 is disabled, as described above. However, the third party may still use first assembly 15 to remotely control operations of user-operated assembly 10. Accordingly, a third party uses first assembly 15 to operate user-operated assembly 10, but does not have the ability to make speed/quick pay system transactions using private financial data belonging to the user (e.g., an owner of user-operated assembly 10 who gives first assembly 15 to the third party).

Communication device 5 may allow the incorporation of a speed/quick pay system into a device such as a keyfob for a vehicle. The speed/quick pay system of communication device 5 may be easily disabled, when desired, by a user. The technique for disabling the speed/quick pay system of communication device 5 by the user may involve little training of the user. Communication device 5 may also ensure water-tight sealing of electronics. Also, communication device 5 may provide a technique for implementing a speed/quick pay system that has a negligible impact on visible surfaces of communication device 5 to a user.

It will be apparent to those skilled in the art that various modifications and variations can be made to the disclosed adaptive speed pay automotive module and method. Other embodiments will be apparent to those skilled in the art from consideration of the specification and practice of the disclosed method and apparatus. It is intended that the specification and examples be considered as exemplary only, with a true scope being indicated by the following claims and their equivalents.

1. (canceled)

2. A communication device, comprising:
a first assembly including a controller, a first communication element, and a speed pay communication element, the controller configured to use the first communication element to control an operation of a user-operated assembly;
a second assembly including an electronics element configured to operate with a speed pay system, the second assembly being removably attachable to the first assembly;
wherein the controller, the speed pay communication element, and the electronics element are configured to operate with the speed pay system when the first assembly and the second assembly are attached to each other; and
wherein the operation of the communication device with the speed pay system is disabled when the first assembly and the second assembly are detached from each other.

3. The communication device of claim 2, wherein the electronics element is overmolded onto a body of the second assembly.

4. The communication device of claim 2, wherein the controller, the speed pay communication element, and the electronics element operate as a speed pay subsystem of the communication device when the first assembly and the second assembly are attached to each other.

5. The communication device of claim 2, wherein the communication device is a keyfob and the first assembly is a fob.

6. A method for using a communication device to operate with a speed pay system, comprising:
providing a first assembly including a first communication element and a speed pay communication element;
using the first communication element to control an operation of a user-operated assembly;
providing a second assembly including an electronics element, and using the electronics element to operate with a speed pay system;
attaching the first assembly and the second assembly together to allow the controller, the speed pay communication element, and the electronics element to operate with the speed pay system; and
detaching the second assembly from the first assembly to disable the operation of the communication device with the speed pay system.

7. The method of claim 6, wherein providing the second assembly includes overmolding the electronics element onto a body of the second assembly.

8. The method of claim 6, further including forming a sealed connection when attaching the first assembly and the second assembly together.

9. The method of claim 8, wherein the sealed connection includes a USB connection.

10. The method of claim 8, wherein the sealed connection is a water-tight sealed connection.

11. A vehicle keyfob, comprising:
a fob including a controller, a first antenna, and a speed pay antenna, the controller configured to use the first antenna to control a vehicle operation;
an assembly including a circuit configured to operate with a speed pay system, the assembly being removably attachable to the fob;
wherein the controller, the speed pay antenna, and the circuit are configured to operate with the speed pay system when the fob and the assembly are attached to each other; and
wherein the operation of the keyfob with the speed pay system is disabled when the fob and the assembly are detached from each other.

12. The communication device of claim 11, wherein the fob includes a first connector and the assembly includes a second connector.

13. The communication device of claim 12, wherein the fob and the assembly, and the first connector and the second connector, form a sealed connection when the fob and the assembly are attached to each other.

14. The communication device of claim 13, wherein the first connector and the second connector together comprise a USB connector.

15. The communication device of claim 13, wherein the sealed connection is a water-tight sealed connection.

16. The communication device of claim 11, wherein the assembly includes a hidden keyblade.

17. The communication device of claim 11, wherein the circuit includes a near-field communication device.

18. The communication device of claim 11, wherein the vehicle keyfob further comprises a second antenna, wherein the first antenna includes an RF antenna and the second antenna includes an LF antenna.

19. The communication device of claim 11, wherein the controller includes one or more of a microcontroller circuit and a near-field communication device.

20. The vehicle keyfob of claim 10, wherein the assembly includes a hidden keyblade.

21. The vehicle keyfob of claim 10, wherein the speed pay antenna operates at 13.56 MHz.
